(19) United States
(12) Patent Application Publication
(10) Pub. No.: US 2003/0036975 A1
(43) Pub. Date: Feb. 20, 2003

(54) Method of conducting an electronic rolling auction permitting the auction sponsor to make changes to the auctioned item

(76) Inventors: Joshua J.D. Martin, Arlington, VA (US); Ingrid M. Solis, Rockville, MD (US)

Correspondence Address: William T. Ellis, FOLEY & LARDNER, Washington Harbour, 3000 K Street, N.W. Suite 500, Washington, DC, 20007-5109, US

(21) Appl. No.: 09/920,323

(22) Filed: Aug. 2, 2001

(51) Int. Cl. G06F 17/60

(52) U.S. Cl. 705/27

(57) ABSTRACT

There is provided a method, program product and system for conducting an auction facilitated by a computer network wherein the auction sponsor is provided the ability to modify the auction parameters while the auction is underway. The method, program product and system for refreshing an on-going electronic auction, comprises the steps of: determining that an auction parameter has been changed; and automatically refreshing a copy of the auction at a browser of an auction participant. In one embodiment, the determining step comprises determining if an indicator has been set at the auction server side to indicate that an auction parameter has changed. In a second embodiment, the determining step comprises receiving a communication from the auction server side indicating that an auction parameter has changed.

### FIELD OF THE INVENTION

This invention is related generally to a method of facilitating an auction via the world wide web and specifically to a method for conducting an electronic rolling auction wherein the auction sponsor is able to make changes to the items being auctioned while the auction is underway.

### BACKGROUND OF THE INVENTION

Electronic auctions conducted via the world wide web or Internet have become important vehicles for retail, wholesale and resale sales. Electronic auctions are used by many to buy and sell collectibles and used items. Electronic auctions have also become a backbone linking suppliers, manufacturers, wholesalers and retailers into efficient decentralized networks of commerce.

Electronic auctions may be standard auctions, wherein an auction sponsor offers to sell an item or group of items, and multiple prospective buyers submit bids via electronic components (e.g., electronic mail) of the price they are willing to pay, and the buyer with the highest bid received before the auction closes has the right to purchase the item or items at that bid price. Alternatively, many electronic auctions are reverse auctions, wherein an auction sponsor offers to buy an item or group of items, and multiple prospective sellers submit bids via electronic means of prices at which they are willing to sell the item, and the seller with the lowest bid (or bid with the best overall terms) received before the auction closes has the right to sell the item or items at the bid price to the auction sponsor. Reverse auctions are efficient methods for larger purchasers of suppliers, assemblies or parts to identify suppliers who can provide the best package of price, delivery terms, and volume commitments. Similarly, reverse auctions permit suppliers to efficiently identify prospective clients and the needs of those clients, and respond with offers to meet those needs.

Conducting auctions over the Internet has been accomplished for some time. For example, U.S. Pat. No. 6,202,051 discloses a network of computer nodes linked by computer networks to permit an individual consignment store to offer collectibles for auction to a national network of consignment stores. U.S. Pat. No. 5,744,873 discloses an electronic auction system to permit remote users to participate in a motor vehicle auction using personal computers to search a database containing information on motor vehicle auctions and related information. U.S. Pat. No. 6,058,417 discloses a method and apparatus for managing online trading environments, facilitating person-to-person commerce. U.S. Pat. No. 5,915,209 discloses a system for municipal bond trading including conducting private electronic auctions. U.S. Pat. No. 5,966,699 discloses a system and method for conducting loan auctions via the Internet, permitting multiple lenders to submit bid loan terms for loan applications stored in a database.

Known electronic auction systems suffer from the common limitation that the auction sponsor must post the item or group of items offered for sale or purchase on a database and is precluded from amending, extending or otherwise altering the auction until the auction is closed, and then only by posting another auction. For sellers of individual items, such as collectibles, such limitations are acceptable. However, for sellers and purchasers of large volumes or a variety of parts or goods, the feedback received from bidders during an auction may inform the sponsor that the auction could be improved if the auctioned quantities, offered groups of items or offered terms for sale or purchase were changed. With current electronic auction systems, the auction sponsor is unable to make use of such insight until the auction is closed and a second auction initiated.

### SUMMARY OF THE INVENTION

Briefly, the present invention comprises, in one embodiment, a method for refreshing an on-going electronic auction, comprising the steps of: determining that an auction parameter has been changed; and automatically refreshing a copy of the auction at a browser of an auction participant.

In a further aspect of the present invention, the determining step comprises determining if an indicator has been set at the auction server side to indicate that an auction parameter has changed.

In a further aspect of the present invention, the indicator determining step comprises refreshing an updater object; and determining if the value in the refreshed updater object indicates that an auction parameter has changed.

In a further aspect of the present invention, the determining step comprises receiving a communication from the auction server side indicating that an auction parameter has changed.

In a further aspect of the present invention, the determining step comprises the step of determining if the communication is from an authorized party.

In a further aspect of the present invention, the step is provided of displaying a notice that web page content has been changed.

In a yet further embodiment of the present invention, a method is provided for conducting an electronic auction, comprising the steps of: during an on-going electronic auction session, updating the auction with a changed auction parameter; and creating an indication of an updated auction.

In a yet further embodiment of the present invention, a method is provided for conducting an electronic auction, comprising the steps of: during an on-going electronic auction session, updating the auction with a changed auction parameter; and periodically refreshing the auction web page.

In a yet further embodiment of the present invention, a program product is provided containing machine readable programming code for causing a machine to perform the following method steps to refresh an on-going electronic auction: determining that an auction parameter has been changed; and automatically refreshing a copy of the auction at a browser of an auction participant.

In a yet further embodiment of the present invention, a program product is provided containing machine readable program code for causing a machine to perform the following steps to conduct an electronic auction: during an on-going electronic auction session, updating the auction with a changed auction parameter; and creating an indication of an updated auction.

In a yet further embodiment of the present invention, a program product is provided containing machine readable for causing a machine to perform the following method steps to conduct an electronic auction: during an on-going electronic auction session, updating the auction with a changed auction parameter; and periodically refreshing an auction web page at a browser of an auction participant.

In a yet further embodiment of the present invention, a system is provided for refreshing an on-going electronic auction, comprising: a component for determining that an auction parameter has been changed; and a component for automatically refreshing a copy of the auction at a browser of an auction participant.

In a yet further embodiment of the present invention, a system is provided for conducting an electronic auction, comprising: a component for, during an on-going electronic auction session, updating the auction with a changed auction parameter; and a component for creating an indication of an updated auction.

In a yet further embodiment of the present invention, a system is provided for conducting an electronic auction, comprising: a component for, during an on-going electronic auction session, updating the auction with a changed auction parameter; and a component for periodically refreshing an auction web page at a browser of an auction participant.

### BRIEF DESCRIPTION OF THE DRAWINGS

FIG. 1 is a tic block diagram of an overall layout for implementing the present invention.

FIG. 2 is a tic block diagram of the auction communication in accordance with the present invention.

FIG. 3 is a block diagram flowchart of a preferred method for implementing the present invention.

FIG. 4 is a tic diagram of a web page in accordance with a preferred embodiment of the present invention.

### DETAILED DESCRIPTION OF THE PREFERRED EMBODIMENTS

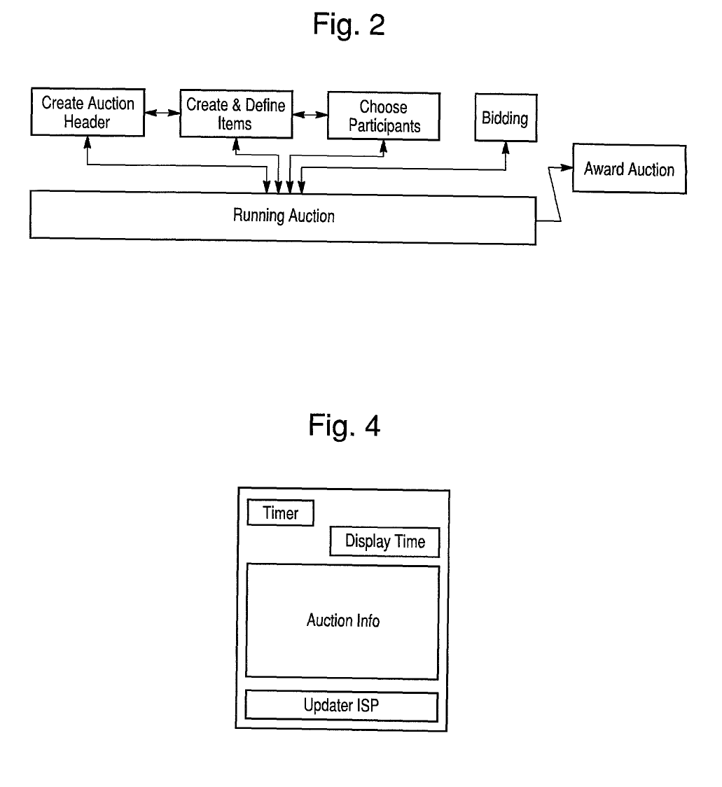

The present inventors have realized that electronic auctions may be improved if an auction system enables auction sponsors to modify one or more of the parameters of the auction while the auction is underway. By enabling auction sponsors to modify the auction item database and providing electronic notifications to participating bidders when such changes are made to the auction, the present invention permits auction sponsors to react dynamically to information and insight provided by bidder responses in order to offer a combination of items, quantities, payment, delivery, pricing and other parameters that will yield the best available deal for the auction sponsor. A conceptualized block diagram of an auction system and method using the design of the present invention is shown in FIG. 2. The arrows at each end of the connecting communication lines indicate a two-way communication, wherein the auction can be updated during the auction.

For purposes of the present invention, the party soliciting bids may be referred to as the sponsor of the auction. In either a forward auction or the reverse auction, the sponsor provides information about the auction including, for example, the product of interest, details regarding how much of the product is needed or available for sale and when, as well as any other relevant information. The sponsor may also include details as to how the auction process is run, such as whether or not the participants are allowed to see the bids of other participants during the auction and the criteria for winning the auction. The description and details of the auction may be referred to collectively as the event. The sponsor may also designate who is invited to participate in the process. The invited participants each review the event and submit bids in response. At this point, the sponsor of the auction may elect to award the winning bid, reject it and close the process, or host another auction.

The auction process, whether it be forward or reverse, may be automated using one or more computers interconnected within a local network or via the Internet. For example, a server computer may include programming structure enabling it either to run the forward auction engine and/or to run the reverse auction engine. The sponsor of the event for the process running on the server could log on or connect to the server to post the event, and participants could then log on or connect to the server to review the event and post their bids. Subsequently, the sponsor could evaluate the bids and take an action based on the evaluation.

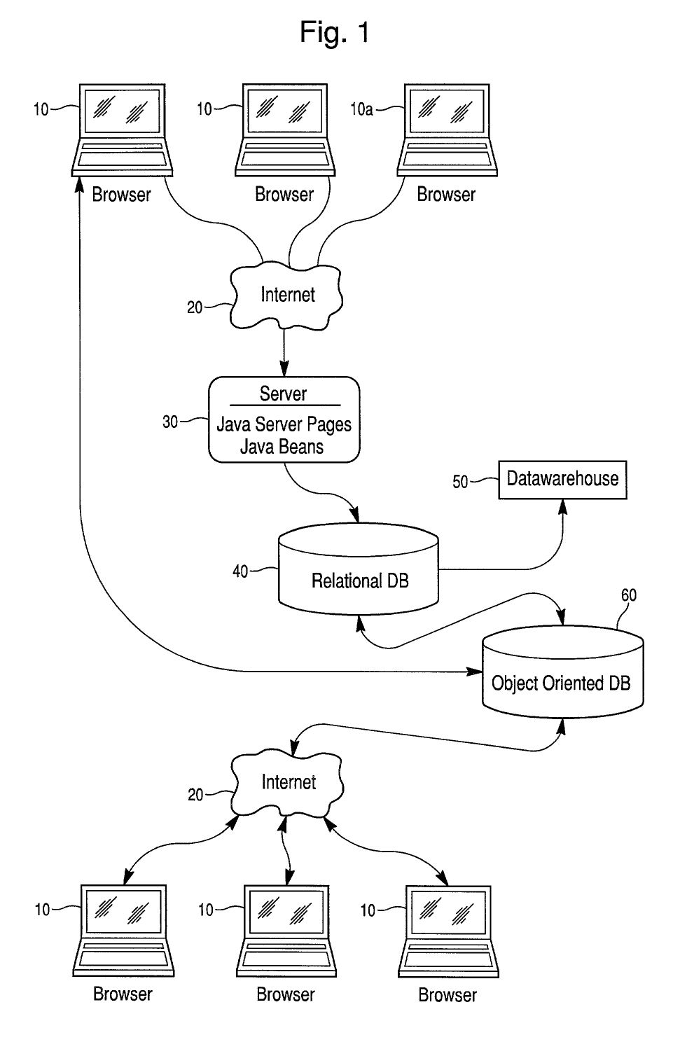

Referring now to FIG. 1, there is shown a simplified view of an exemplary client-server auction environment, such as the Worldwide Web (the Web), in which online auction commerce may take place. The terms “client” and “server” are used to refer to a computer's general role as a requester of data (the client) or provider of service (the server). In FIG. 1, a plurality of web clients 10 are shown connected to the Internet 20.

By way of example but not by way of limitation, a typical user web client 10 would be implemented as a personal computer, PDA or other type of processing system capable of transmitting and receiving information over a network. The client 10 would include a device for entering information, such as a keyboard and a mouse, and a device for viewing information, such as a monitor. The clients 10 are connected via a network connection, such as an Ethernet connection, or a TCP/IP connection to the Internet 20.

A Web server 30 is shown connected to the Internet 20. An exemplary server that may be used to implement the present invention might comprise a bus or other communication means for communicating information, and processing components such as one or more processors coupled with the bus for processing the information. The server 30 would further comprise random access memory (RAM) or other dynamic storage, referred to as main memory, coupled to the bus for storing information and instructions that are to be executed by the processor. The main memory may also be used for storing temporary variables or other intermediate information during execution of instructions by the processor. The server also typically comprises a read only memory (ROM) and/or other static storage device coupled to the bus for storing static information and instructions for the processors. The server would also include a communication device coupled to the bus for accessing remote servers and browsers via the Internet. The communication device may include a modem, a network interface card, or other commercially available network interface device, such as those used for coupling to an Ethernet, token ring, or other type of network. Accordingly, this server 30 may be coupled to a plurality of clients 10 or other servers via a conventional network infrastructure, such as a company's Intranet and/or the Internet. A data packet assembler/dissembler (PAD) would also be included in one embodiment in order to interconnect the server to the various browsers on the network and to efficiently communicate packets data therebetween.

Web clients 10 and Web servers 30 communicate using a protocol such as HyperTextTransferProtocol (HTTP) or other convenient protocol. In the Web environment, the web clients 10 use resident browsers to access and render Web (documents) pages served by the Web server(s) 30. The client-server model is used to communicate information between clients and servers. Web servers are coupled to the Internet 20 via a TCP/IP or other convenient connection and respond to document requests and/or other queries from Web clients 10. When a user selects a document by submitting it's Uniform Resource Locator (URL), the user's Web client browser, such as Internet Explorer or Netscape Navigator, opens a connection to a server and initiates a request (e.g., and HTTP gets) for the document. The server delivers the requested document, typically in the form of a text document coded in a standard markup language such as Hyper Text Markup language (HTML) or in a client server application language, such as visual basic or JAVA.

FIG. 1 further includes a relational database 40, that contains listings of the items of data to be auctioned, with the parameters of each of these items. The relational database 40 maybe implemented, by way of example but not by way of limitation, on an SQL Server. The SQL Server for the relational database 40 uses structured query language to allow all auction participants to access the relevant relational database(s), typically via the Destination Address for the SQL server.

FIG. 1 further includes a data warehouse 50 for maintaining records of completed auctions for purposes of generating reports. Typically, this data warehouse 50 would be implemented using report templates to generate the reports on a periodic or an ad hoc basis.

FIG. 1 may also include an object oriented database 60, if the implementation uses an object oriented programming language. The object oriented database 60 may be used, in an optional implementation, to store a main auction object and a plurality of auction-parameter objects. Note that an object oriented database is utilized when relational queries are not needed, and speed is paramount. These databases store the objects from the object-oriented programming language itself, not breaking them down into rows and fields of data that would be input into a relational database. While relational databases give users the ability to perform powerful cross-table queries (e.g. “Select all auctions where the Buyer is ‘Adam Martin’ and the awarded price is higher than ‘5,000’”), these queries occupy CPU time. Object oriented databases store an Auction object as is—for quick retrieval later (e.g. “Give me the auction with ID=‘32DSA3’”). Each object stored in the OODB will have a unique identifier. Certain aspect of the present invention will be explained in the context of an object oriented language for convenience. However, the present invention is not limited to the use of objects.

Logging on to the server 30 is preferably done through a secure connection process. For example, after registering as users on the server 30 for one or more auction engines (a software component to be discussed below), a sponsoring client 10A (one of the Web clients 10) and the participant Web clients 10 would be prompted to use unique usernames and passwords to log on to the server, thereby ensuring that only registered users are capable of accessing the one or more auction engines. In addition, all information transferred between the sponsoring client 10 and the server 30 may be encrypted to ensure the security of the information.

By way of example but not by way of limitation, the auction engine may be implemented with a single software component. A component is a self-contained re-deployable piece of software code, which may be generic enough to provide functionality for multiple processes. The component comprises pre-developed pieces of application code that can be assembled into working application systems. The single software component is also adaptable and changeable to accommodate new and additional processes.

When an object oriented programming language is used to implement the business logic for the auction, then the core programming structure of the auction software component may be referred to as the auction object. In an object oriented context, auction parameter objects would represent the auction parameters and would point to the auction object. Such auction parameter objects might include the name of the auction, the start/end time of the auction, the items being bought or sold, the participants, the direction of the auction (reverse or forward), the type of auction, awarding criteria and any other detail that may be used in an auction object. The auction-parameter objects also provide functionality used to run an auction. For example, one auction-parameter object may provide functionality for a forward auction, and another auction-parameter object may provide functionality for a reverse auction. Based on the information provided by the sponsoring client 10A, the auction object will point to the auction-parameter objects that are to be used to run the auction. For example, if the sponsoring client 10A elects to run a reverse auction, the auction object will point to the auction-parameter object corresponding to the reverse auction.

The single software component for the auction engine can be expanded to cover different types of auctions or use additional information by incorporating new auction-parameter objects having new functionality into the single software component. To use the new functionality, the auction object is merely altered to point to the new auction-parameter object. The single software component may be implemented using Java, although other object-oriented or structured languages may be used.

A process for using forward and reverse auction processes consistent with the present invention comprises initially logging on to the server 30. The manner in which the sponsoring client 10A logs on to the server 30 depends upon the configuration of the sponsoring client 10A and the server 30. For the example, for a server 30 accessible by the Internet the sponsoring client 10A may simply log on to the server 30 by accessing a web page for the auction. Alternatively, if the server 30 and the sponsoring client 10A are implemented in the same LAN, then the sponsoring client 10A may log on to the server 30 by logging on to the LAN itself.

In either case, the sponsoring client 10A may be prompted to provide a username and password to access the server 30 before being given access. If the sponsoring client 10A has not previously registered with the server 30, the sponsoring client 10A may be prompted to do so. To register with the server 30, the sponsoring client 10A may provide identification and contact information, such as name, address, telephone number and e-mail address, as well as billing information, such as a credit card number.

After logging on to the server 30, the sponsoring client 10A selects the option to create and conduct an auction. The sponsoring client 10A may effect the selection with a mouse click or with a keyboard entry or in another convenient manner.

In response to the selection of the request to create an auction, the sponsoring client 10A is prompted to create an event for the auction and input the auction parameters to create the auction parameter objects. The auction parameters include all of the details regarding a product that the sponsoring client 10A is seeking to purchase or to sell. These details include, for example, the name of the auction, the start and end time of the auction, the name of the product, a description of it, a target price, the amount to be purchased or sold, the timing for a contract and delivery of the product, other terms and conditions, and the currency type. The details of the auction may further include several bidding options, such as the lot type, the reserve price, the minimum number of bidders for starting the auction, the type of bid feedback and the amount of bid increments or decrements. In addition, the details of the auction may include extensions, as well as activity and inactivity rules, and the direction of the auction, and any other information that may be useful to the participating client 10 when submitting a bid. In addition, the event may include attachments, such as figures, drawings, pictures or text, which help to describe the product more completely. The event may also include a list of participating clients 10 from which the sponsoring client 10A wishes to solicit bids. The list of participating clients 10 may be considered part of or separate from the creation of the event. Each or selected ones of these auction parameters may be designated as changeable, e.g., can be changed after the auction event is commenced.

As noted, in one embodiment, each auction parameter may comprise an auction parameter object, with a reference being made between the auction object and the auction-parameter object. The reference may be a pointer to the auction-parameter object and its associated information stored in the relational database 40. The sum of the auction object and each of the auction-parameter objects to which the auction object points constitutes the event. With all of the information for the event entered, the event is posted to the server 30 to the appropriate software auction component and the event information stored in the relational database 40.

In response to the posting of the event, the auction is conducted. The auction starts at the start time indicated in the auction object. The participating clients 10 designated by the event information in the auction object may receive notification of the posted event to inform the participating clients 10 to submit a bid. This notification may be, for example, by e-mail or by providing an indication when a participating client 10 logs onto the auction software component. After logging on to the auction software component at the server 30, the participating client browsers download and open the web page for the auction by clicking on a button on the view screen or in some other convenient manner to thereby review the details of the posted event. This download of the auction web page remains on the browser, unchanged, even if a change is subsequently made to an auction parameter, unless the web page is refreshed.

During the auction, the participating clients 10 can submit bids and otherwise interact with the server 30 in which the event has been posted. If the sponsoring client 10A has designated the structure and content of the bids to be submitted, the participating clients 10 may fill-in information in editable fields corresponding to the content requested by the sponsoring client 10A, such as the timing or intervals over which the product will be delivered, the bid price, and how much of the product will be provided. The participating clients 10 may also enter additional information or comments about its bid, such as better prices available for increased amounts of the product. This interaction may result in the sponsoring client choosing to change one or more of the auction parameters. The present invention is directed to the situation when the event has been posted, but the auction sponsor wishes to change an auction parameter.

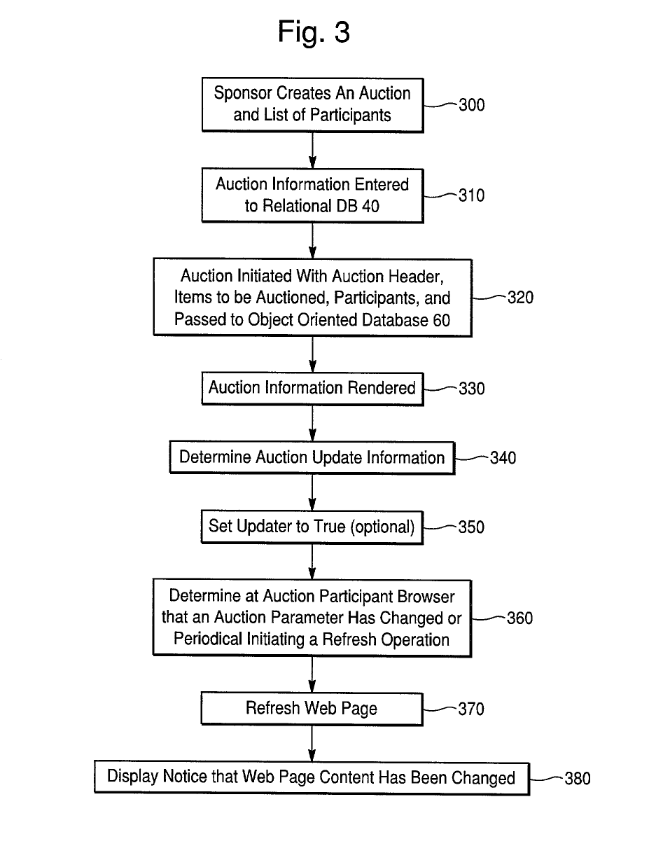

Referring now to FIG. 3, the steps comprising one embodiment of the present invention are provided. The first step, shown as block 300 comprises the step of creating an auction and a list of participants, as discussed above.

The next step represented in block 310 comprises entering auction information into a database, such as the relational database 40 in FIG. 1.

The method further includes the step represented in block 320 of initiating the auction. This would be accomplished by creating, via business logic that may encapsulate a plurality of business rules (e.g., “if an auction has reached its time limit, stop it, and place the award price entered at the browser into the database 40), a web page GUI with appropriate information, for example, including an auction header, the items to be auctioned, and determining auction participants. In an object oriented embodiment, the business logic creates an auction object and a plurality of auction parameter objects.

The method further includes the step represented by block 330 of rendering the auction information on browsers of various auction participants using web content.

The method further includes the step represented in block 340 of determining that one or more items of auction information are to be changed, for example information in the auction header such as auction start time, auction end time, etc., as well as the items to be auctioned, and changes to how the items to be auctioned are aggregated, and various other parameters.

In one embodiment of the invention, the method further includes the step represented in block 350 of setting an indicator, such as a parameter called “updater” to “TRUE.” The is an optional step. One alternative to this step, discussed with respect to step 360, encompasses performing a comparison to determine if changes have been made in the datastore for the auction. As a further alternative, a component from the server side could generate a communication to notify participants of an auction parameter change.

The method further includes the step represented in block 360 of determining at an auction participant that an auction parameter has been changed. The step 360 can be performed using a number of different methods based on querying the auction web site for auction changes, or based on receiving a communication from the auction web site that a change has occurred. In a preferred embodiment, in order to display the most updated auction information, the auction participant's web page queries the server 30, or the relational database 40 or queries some other server side location which would determine if auction information has changed. In one embodiment, this operation might comprise determining if an indicator “updater” is set to “TRUE.” There are a number of options available to accomplish the determination using the query method. Each is discussed below. In a further embodiment of the determination step 360, the determination can be made by receiving a communication from an external source such as the server 30, or the relational database 40, or the object database 60, indicating that auction information has changed. Receipt of this communication invokes a method to initiate a fresh of the entire auction web page.

The method further includes the step as represented in block 370 of refreshing the auction web page if the determination is that a change has been made to an auction parameter.

In a preferred embodiment, the method also includes the step as represented in block 380 of displaying a notice to the user either on his/her browser or elsewhere, that the auction web page content has been changed.

A discussion of a manual refresh operation will be provided to set the context for a more detailed discussion of the query method referenced above for making the determination that a change has occurred in an auction parameter. A manual refresh occurs when a user selects the Refresh button in the browser. This selection causes the web page to reload. The web page is designed to query a database during the reload, and then present the results in a meaningful way to the user. The following shows the basic structure of the web page (in this case a JSP).

// Create an object to hold the results of the query
AuctionInformation auctionInfo = new AuctionInformation();
// Create an Auction object based on the current auction ID.
Auction thisAuction = new Auction(“321FDS3FG”);
// Create a Map object to store credentials required to extract data from
the
// database.
HashMap userInformation = new HashMap();
userInformation.put(“username”, “solisi”);
userInformation.put(“password”, “booyaw”);
// Obtain, via an SQL query or other convenient code to query a database,
//the most updated information from the database, using the reference to
//this auction and the login credentials, and put the results in the auction
//info object.
auctionInfo = DataExtractor.getAuctionData(thisAuction,
userInformation);
// Draw the page with the auction information
<HTML>

<BODY>

<!-- Presentation goes here -->

</BODY>

</HTML>

In this way, each time the page is refreshed, the database is queried, and the information displayed is the most recent. An analogy would be hitting refresh in a browser to obtain the most recent Yahoo! stock quotes.

Timed Refresh

The timed refresh is nearly identical to the previous example, the only difference being automation. In a preferred embodiment, Javascript is used to provide a mechanism for inserting a timer into a web page that will automatically call a stated Javascript refresh function every x seconds. For example, the timer could refresh the page automatically every 30 seconds.

Timed Update Check

Both options above refresh the web page regardless of updated information. That is, the entire page refreshes whether or not there is new information. In a further aspect, a method is provided that will only refresh the entire page if new information is present. One example to accomplish this task for an embodiment in the context of HTML, would include an HTML structure called a frameset. A frameset allows a webpage to be broken into several areas (frames), each containing its own web page. The frames may be visible or invisible to the end user. In an example implementation, there is one frame that will be hidden from the user, named Updater.

As in the previous example, a timer counts for the specified period of time (e.g. 30 seconds). At this point, it refreshes only the hidden updater frame. The updater frame contains code consistent with the following:

// Place a flag for the Javascript to call refresh
boolean refresh = false;
// Create an object to hold the results of the query
AuctionInformation auctionInfo = new AuctionInformation();
// Create an Auction object based on the current auction ID.
Auction thisAuction = new Auction(“321FDS3FG”);
// Create a Map object to store credentials required to extract data from
the
// database.
HashMap userInformation = new HashMap();
userInformation.put(“username”, “solisi”);
userInformation.put(“password”, “booyaw”);
// First see if there is any updated information by using the method
//DataExtractor.isAuctionUpdated. This method returns a value that is
//either TRUE or FALSE.
boolean updated = DataExtractor.isAuctionUpdated(thisAuction,
userInformation);
// Only update the page if updated is TRUE.
if(updater)

// Obtain the new data and draw the page as before
.
.
.
refresh = true;

} else {

refresh = false;

}

Notice that the refresh variable is set to true only if the entire page is to be refreshed. The calling Javascript function uses this value of updater to determine whether or not to reload the remainder of the page.

FIG. 5 is a tic block diagram of a layout of a web page 500 using a timer function 510 and an updater object 520. The web page also shows the display time and auction information. The updater component 520, a hidden component, is refreshed at a set interval. A timer object 510 (available in Javascript) refreshes/reloads the hidden updater component 520 at a set interval. On reload, the updater component checks a boolean flag on the server side. This flag value is set to TRUE when changes have been made to the auction in the database. If the flag is TRUE, the updater queries the database, obtaining the most recent auction information. The updater then sets the flag to FALSE, and refreshes the other page components with the new auction information. The flag will remain FALSE until new changes occur to the auction in the database. If the updater encounters a FALSE flag, it does nothing.

While the invention has been described in detail and with reference to specific embodiments thereof, it will be apparent to one skilled in the art that various changes and modifications can be made therein without departing from the scope of the invention. Thus, the breadth and scope of the present invention should not be limited by any of the above-described exemplary embodiments, but should be defined only in accordance with the following claims and their equivalents.

What is claimed is:

1. A method for refreshing an on-going electronic auction, comprising the steps of:
determining that auction parameters have been changed; and
automatically refreshing a copy of the auction at a browser of an auction participant.

2. The method as defined in claim 1, wherein the determining step comprises determining if an indicator has been set at the auction server side to indicate that an auction parameter has changed.

3. The method as defined in claim 2, wherein the indicator determining step comprises refreshing an updater object; and determining if the value in the refreshed updater object indicates that an auction parameter has changed.

4. The method as defined in claim 1, wherein the determining step comprises receiving a communication from the auction server side indicating that an auction parameter has changed.

5. The method as defined in claim 1, wherein the determining step comprises the step of determining if the communication is from an authorized party.

6. The method as defined in claim 1, further comprising the step of displaying a notice that web page content has been changed.

7. A method for conducting an electronic auction, comprising the steps of:
during an on-going electronic auction session, updating the auction with a changed auction parameter; and
creating an indication of an updated auction.

8. The method as defined in claim 7, wherein the creating an indication step comprises setting an update value to indicate a changed parameter.

9. The method as defined in claim 7, wherein the creating an indication step comprises sending a communication indicating an updated auction parameter to auction participants.

10. A method for conducting an electronic auction, comprising the steps of:
during an on-going electronic auction session, updating the auction with a changed auction parameter; and
periodically refreshing an auction web page at a browser of an auction participant.

11. A program product containing machine readable programming code for causing a machine to perform the following method steps to refresh an on-going electronic auction:
determining that an auction parameter has been changed; and
automatically refreshing a copy of the auction at a browser of an auction participant.

12. The program product as defined in claim 11, wherein the code for the determining step comprises code for determining if an indicator has been set at the auction server side to indicate that an auction parameter has changed.

13. The program product as defined in claim 12, wherein the code for the indicator determining step comprises code for refreshing an updater object; and determining if the value in the refreshed updater object indicates that an auction parameter has changed.

14. The program product as defined in claim 11, wherein the code for the determining step comprises code for receiving a communication from the auction server side indicating that an auction parameter has changed.

15. The program product as defined in claim 11, wherein the code for the determining step comprises code for determining if the communication is from an authorized party.

16. The program product as defined in claim 11, further comprising code for performing the step of displaying a notice that web page content has been changed.

17. A program product containing machine readable program code for causing a machine to perform the following steps to conduct an electronic auction:
during an on-going electronic auction session, updating the auction with a changed auction parameter; and
creating an indication of an updated auction.

18. The program product as defined in claim 17, wherein the code for creating an indication step comprises code for setting an update value to indicate a changed parameter.

19. The program product as defined in claim 18, wherein the code for creating an indication comprises code for sending a communication indicating an updated auction parameter to auction participants.

20. A program product containing machine readable for causing a machine to perform the following method steps to conduct an electronic auction:
during an on-going electronic auction session, updating the auction with a changed auction parameter; and
periodically refreshing an auction web page at a browser of an auction participant.

21. A system for refreshing an on-going electronic auction, comprising:
a component for determining that an auction parameter has been changed; and
a component for automatically refreshing a copy of the auction at a browser of an auction participant.

22. A system for conducting an electronic auction, comprising:
a component for, during an on-going electronic auction session, updating the auction with a changed auction parameter; and
a component for creating an indication of an updated auction.

23. A system for conducting an electronic auction, comprising:
a component for, during an on-going electronic auction session, updating the auction with a changed auction parameter; and
a component for periodically refreshing an auction web page at a browser of an auction participant.
